(19) United States
(12) Patent Application Publication
(10) Pub. No.: US 2009/0120969 A1
(43) Pub. Date: May 14, 2009

(54) Pouring aid

(75) Inventors: Jason Hughes, Queensland (AU); Robert Gulbrandson, Queensland (AU); Sherryl Robertson, Queensland (AU); Rodney John Granat, Victoria (AU); Michael Sweeney, Queensland (AU)

Correspondence Address: VOLPE AND KOENIG, P.C., UNITED PLAZA, SUITE 1600, 30 SOUTH 17TH STREET, PHILADELPHIA, PA, 19103, US

(73) Assignee: Gravity Solutions Pty Ltd, Keperra, Queensland (AU)

(21) Appl. No.: 11/911,348

(22) PCT Filed: Feb. 2, 2006
(86) PCT No.: PCT/AU06/00119

§ 371 Date: Jun. 5, 2008

(30) Foreign Application Priority Data
Apr. 19, 2005 (AU) 2005901931
Sep. 14, 2005 (AU) 2005209696

(51) Int. Cl. B67D 3/00; B65D 25/40; B65D 41/04

(52) U.S. Cl. 222/479; 222/566

(57) ABSTRACT

A container comprising, a container body, a tubular spout having a forward portion and a rearward portion which is mounted on the container body, a closure for sealing the tubular spout, and a baffle extending across and partly closing off the tubular spout leaving an open liquid outlet, wherein the fixed baffle comprises an element of a separate insert which is slidable into the tubular spout through the forward portion, the separate insert having an air inlet.

### FIELD OF THE INVENTION

This invention relates to a pouring aid. It relates particularly but not exclusively to the incorporation of a pouring aid in the spout of a container to smooth the flow of pouring liquid from the container especially when the container is relatively full with liquid.

### BACKGROUND OF THE INVENTION

Containers for bulk handling of liquids (i.e. in excess of 1 or 2 litres of liquid) are often formed with a small spout on the front face of the container, the spout being positioned close to an edge of the front face.

Typically, the small spout will be sealed with a closure which may be screwed onto the spout to seal it.

Especially when the container is full of liquid, it has been found that the normal method of pouring liquid through the spout of such a container, involving turning the container so that the spout is at a lower level and tipping the container to pour liquid out of the spout, results in splashing and uneven flow of the liquid from the spout. This is because air has to enter the spout to compensate for the vacuum created in the container as the liquid pours out of the spout. The air enters as discrete bubbles which periodically interrupt the flow followed by a sudden increase in flow as each bubble has passed through the spout.

The present invention seeks to provide a construction which seeks to ameliorate the problems associated with the above described conventional pouring approach.

### DISCLOSURE OF THE INVENTION

The invention provides in one aspect a container comprising,
a container body,
a tubular spout having a forward portion and a rearward portion which is mounted on the container body,
a closure for sealing the tubular spout, and a baffle extending across and partly closing off the tubular spout leaving an open liquid outlet,
wherein the fixed baffle comprises an element of a separate insert which is slidable into the tubular spout through the forward portion, the separate insert having an air inlet.

The container may typically be a container for handling of liquids i.e. it may generally have a capacity of 0.2 or more litres.

The container may be formed of any suitable material such as is known in the art e.g. plastics, metal, etc.

In one embodiment, the container may comprise a metal body provided with a flat front face. The tubular spout formed on the front face may include attachment means for securing a closure to the spout. The attachment means may comprise a screw thread, the spout having a complementary screw thread.

The insert may comprise a member which is shaped as a plug, with the baffle forming part of the plug. The plug may be a plastic threaded insert which could be screwed onto or into the thread of the spout. In another embodiment it may be shaped so that it can be directly pushed into the spout and held therein by a friction fit. It may be provided with lugs for this purpose. The insert may comprise low density polyethylene.

The insert may also be configured so that it can be retained in a closure. It may be retained by a screw thread which co-operates with the screw thread of the closure. Alternatively it may be retained by an alternative friction fit arrangement such as a feather edge which presses up against the closure skirt.

Suitably, the area represented by the liquid outlet comprises from 10% to 50% of the surface area of the pouring opening provided by the spout. More preferably, it may comprise from 18% to 30% of the surface area.

Similarly, the air inlet may comprise from 0.5% to 20% of the surface area for the spout. More preferably it may comprise from 2% to 10% of the surface area.

The baffle may comprise between 81.5% and 25% of the pouring opening of the spout.

Typically, the spout itself may comprise 1% to 20% of the surface area of the front face where the front face is flat.

Preferred aspects of the invention will now be described with reference to the accompanying drawings.

### BRIEF DESCRIPTION OF THE DRAWINGS

FIG. 1 shows an isometric view of an insert according to the invention;

FIG. 2 shows a different isometric view of the insert of FIG. 1 and a closure;

FIG. 3 shows an isometric view of the closure and insert of FIG. 2 assembled together;

FIG. 4 shows a cross-section of the insert and closure of FIG. 2 applied to the spout of a container;

FIG. 5 shows a cross-section of the insert of FIGS. 1 and 2 fitted to the spout of a container while liquid is being poured;

FIG. 6 is an exploded view of an alternative cap, insert container combination; and

FIG. 7 is a cross section taken through FIG. 6 of the combined container spout and insert.

### DETAILED DESCRIPTION OF THE PREFERRED EMBODIMENTS

The various elements identified by numerals in the drawings are listed in the following integer list.

### INTEGER LIST

19 Liquid outlet
20 Insert
22 Baffle
23 Skirt
24 Flange
25 Feather edge
26 Air inlet
27 Lip
28 Lug
29 Ramp
30 Closure cap
31 Screw thread
32 Container
33 Front face
34 Spout
35 Skirt
38 Sealing surface
39 Internal skirt
40 Liquid
41 Air bubbles
42 Tear line
50 Closure cap
51 Insert
52 Container
53 Spout
56 Top panel
57 Skirt
60 Outer skirt
61 Screw thread
62 Circumferential flange
63 Plug skirt
65 Baffle
66 Air inlet
67 Lip
68 Liquid outlet
69 Ratchet tooth
70 Screw thread
71 Slot
73 Tear line

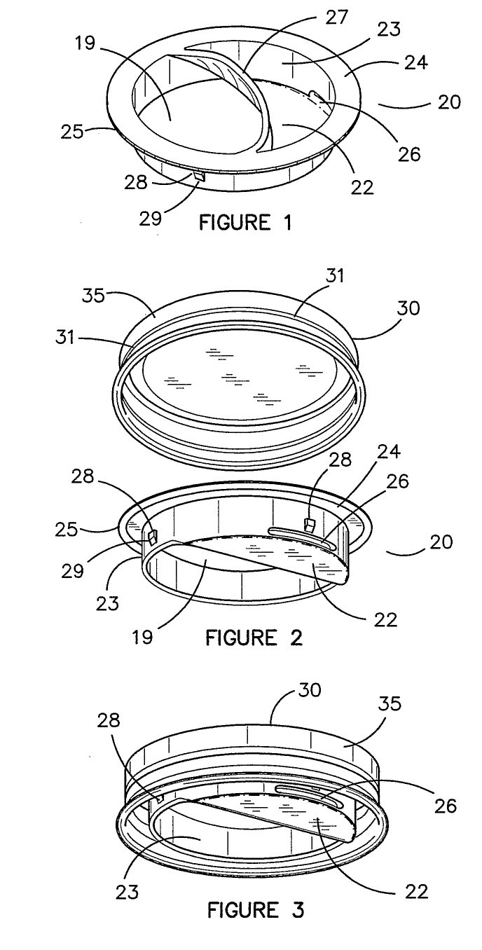

Referring to FIG. 1, there is shown an insert generally designated 20 for use in performing the present invention. The insert may typically be formed as an integral element using a plastics moulding process. The plastics material may comprise low density polyethylene.

The insert comprises a liquid outlet 19 formed between the annular skirt 23 and the lip 27 of the baffle 22. It is to be noted that the baffle 22 is generally flat and is arranged so that it will lie in a direction generally perpendicular to the axis of a spout to which it may be applied. The lip 27, which extends from the baffle, is shaped and angled so as to direct a flow of liquid pouring through the liquid outlet 19. A flange 24 extends outwardly from the top of the skirt and terminates in a feather edge 25 for purposes to become apparent.

An air inlet 26 is formed in the skirt, the air inlet being located near the bottom edge of the skirt proximate the top of the baffle 22. Alternatively it could be located in the baffle near the join between baffle and skirt. It could even extend through both baffle and skirt.

A number of lugs 28 are formed around the skirt, the lugs being formed with ramps 29 to assist with press fitting the insert into the spout of a container.

Referring to FIGS. 2 and 3, it can be seen that the insert is constructed so that it can readily fit into a closure cap 30 so that it sits concentric with the skirt 35 of the cap immediately below the top panel of the cap. Whilst the cap shown is typically formed by pressing and rolling metal as is known in the art, it is to be appreciated that other cap constructions such as plastic moulded caps are also possible.

The feather edge 25 of the insert forms a friction fit with the skirt 35 of the cap in a region of the skirt above the level of the screw thread 31 provided in the skirt.

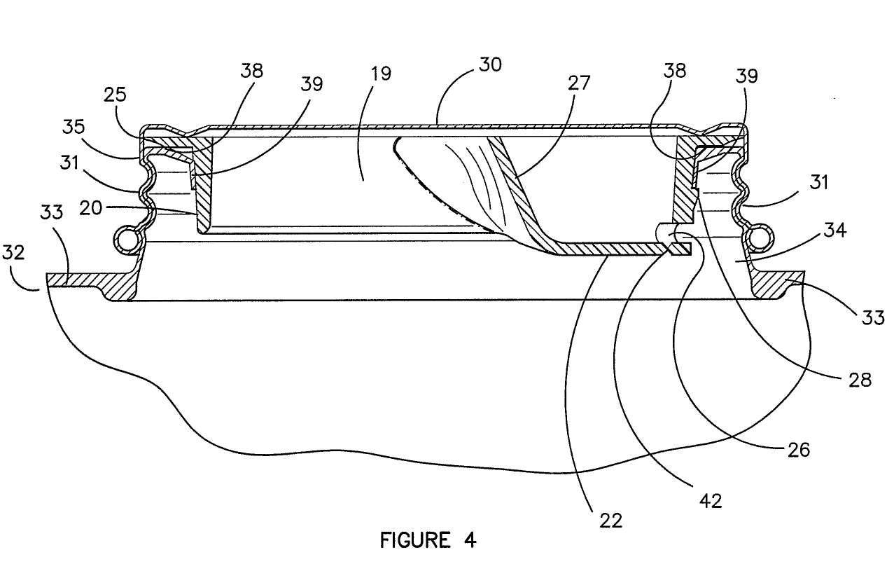

Referring to FIG. 4, it can be seen that the assembled cap and insert of FIG. 3 have been screwed down onto the spout 34 of a container 32. The spout forms an integral part of a flat front face 33 of the metal container, the spout being formed by working the metal so as to form screw threads in the tubular spout which are complementary to the screw thread 31 of the cap.

The spout is also formed with a sealing surface 38 at the forward portion of the spout and an internal skirt 39 which forms a snug fit with the tubular skirt 23 of the insert when the cap is screwed onto the spout.

It can be seen that the lugs 28 are positioned so that they underlie the bottom edge of the internal skirt 39 when the insert is pushed home into the spout 34. As a result, the lugs serve to prevent the insert being removed from the spout when the cap is unscrewed notwithstanding the friction fit caused by the flexible feather edge 25 abutting the internal surface of the skirt 35 of the cap.

The advantage of this construction is that the container can be filled with the spout completely open and the cap and insert can then readily be jointly screwed onto the spout using conventional equipment after the container has been filled. As an optional added feature, the insert may include a tear line 42 in the form of a thinned or scored line of material which allows the lip 27 and baffle 22 to be removed for purposes such as the insertion of a funnel or tube of a pump into the spout.

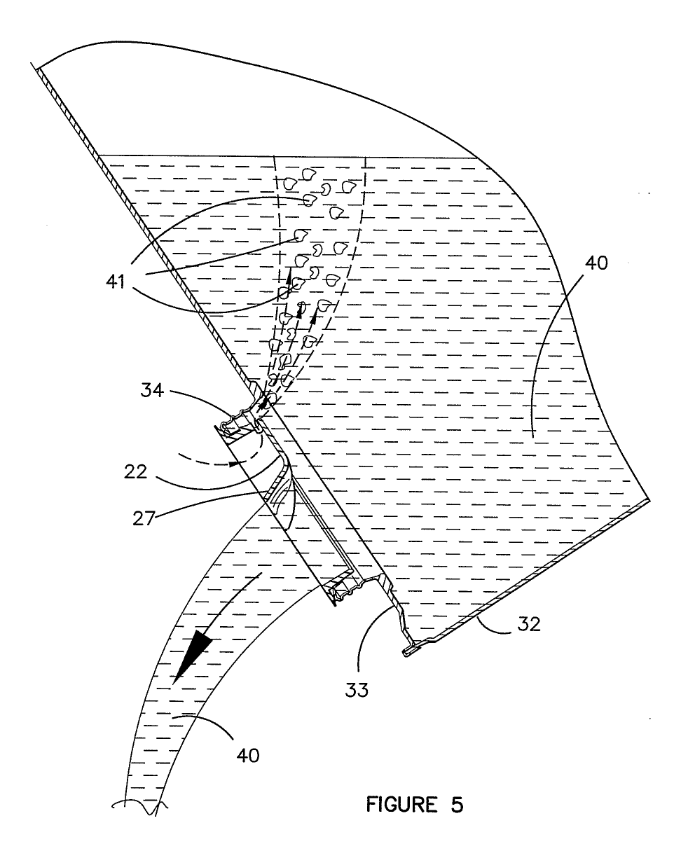

When a user wishes to empty the contents of the container, the user simply removes the closure, manually orients the insert so that the liquid outlet 19 is lowermost relative to the bottom edge of the container and pours liquid 40 out of the container by tilting the container in the conventional manner. The effect of separating the air inlet 26 from the liquid outlet 19 is that air 41 freely bubbles up through the air inlet away from the liquid pouring out of the liquid outlet and the interference which would otherwise occur between air bubbles coming into the container and liquid pouring out is substantially reduced. This is shown in FIG. 5.

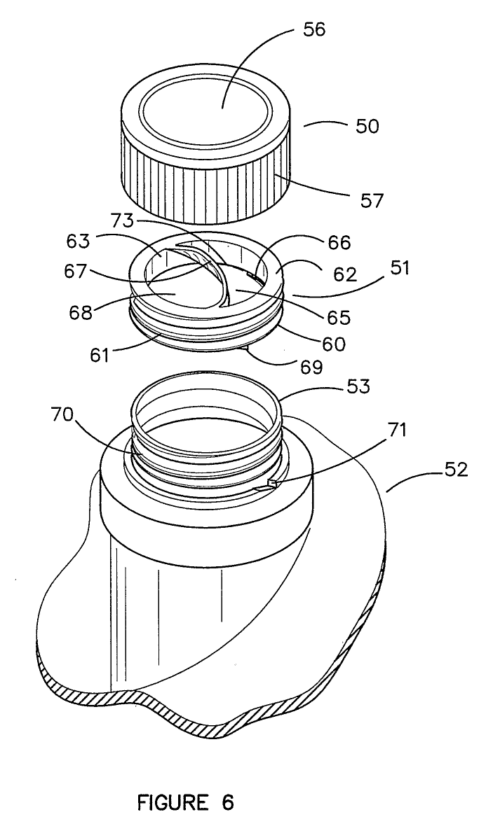

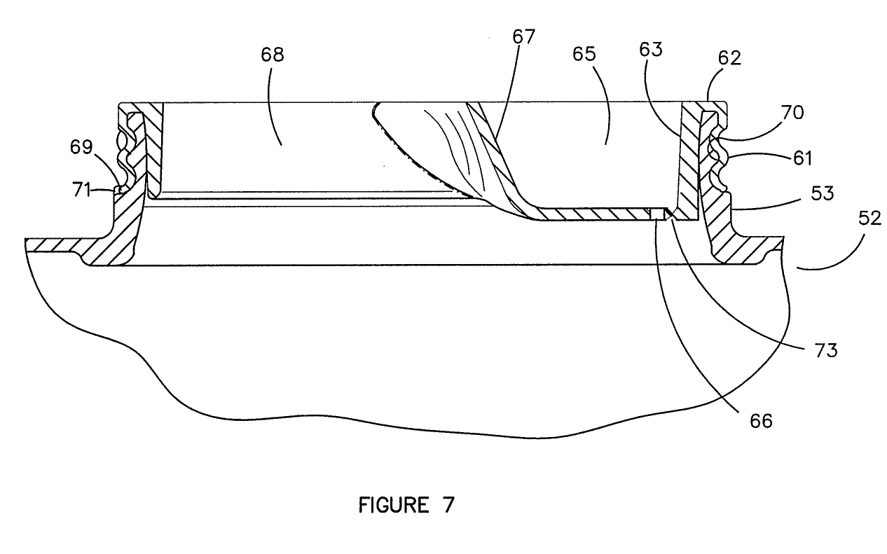

Referring to FIGS. 6 and 7, there is shown an alternative arrangement in which an insert 51 may be screw threaded into the closure cap 50 prior to application by screwing to the spout 53 of a container 52.

The cap may be a conventional closure cap having a top panel 56 and a skirt 57 which depends from the top panel. The interior to the skirt is provided with a screw thread which co-operates with the screw thread 61 provided on the outer skirt 60 of the insert 51 to hold the insert within the cap 50 when the two are screwed together.

Typically, both the closure cap and insert may be produced by conventional plastics moulding techniques.

The outer skirt 60 of the insert is joined by a circumferential flange 62 to a plug skirt 63 which lies surrounded by and concentric with the outer skirt 60.

The plug skirt is shaped so that it fits snugly in telescopic fashion within the spout 53 of the container when the combined cap and insert are screwed onto the spout 53.

A baffle 65 extends partly around and across the region bounded by the plug skirt. It is formed with an air inlet 66 and a lip 67 for assisting with directing pouring of liquid through the liquid outlet 68.

A tear line 73 is provided so that the baffle and lip may be torn away from the insert if a user needs to obtain completely open access to the container spout. For example, a user may wish to insert a funnel or hand pump through the spout of the container.

The spout of the container includes a screw thread 70 for co-operation with the screw thread 61 of the insert. Thus the screw thread 61 is double sided in the respect that on one side it enables the insert to be screwed onto the spout 53 of the container whereas on its opposite side it allows the insert to be screwed into the closure cap 50.

In order to prevent the insert being accidentally removed from the container when the closure cap is unscrewed, the bottom of the outer skirt 60 is provided with one or more ratchet teeth 69 shaped so that they co-operate with one or more slots 71 provided at the bottom of the spout, the ratchet teeth and slots co-operating to prevent reverse rotation of the insert after it has been fully screwed home onto the spout of the container. The slots can be positioned so that they correctly orient the insert for pouring.

The insert functions in much the same way as the inserts described with reference to FIGS. 1 to 5 in smoothing the flow of liquid through the liquid outlet 68 when the container is tilted.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge in Australia.

1. A container comprising,
a container body,
a tubular spout having a forward portion and a rearward portion which is mounted on the container body,
a closure for sealing the tubular spout, and
a baffle extending across and partly closing off the tubular spout leaving an open liquid outlet,
wherein the fixed baffle comprises an element of a separate insert which is slidable into the tubular spout through the forward portion, the separate insert having an air inlet.

2. A container according to claim 1 wherein the container comprises a front face formed as a flat circular metal sheet with the spout provided in a position offset from the centre of the flat circular sheet.

3. A container according to claim 1 wherein the separate insert comprises a moulded plastic plug having a plug skirt which surrounds the baffle.

4. A container according to claim 3 wherein a forward portion of the plug skirt comprises a circumferential flange extending outwardly from a join with the plug skirt and the air inlet is formed in the plug skirt or the baffle.

5. A container according to claim 4 wherein the circumferential flange comprises a circumferential edge portion of lesser thickness than an inner portion of the circumferential flange proximate the join.

6. A container according to claim 3 wherein an outer surface of the plug skirt is provided with a plurality of lugs, the tubular spout is provided with an internal skirt having a bottom edge and the lugs are adapted to underlie the bottom edge so as to secure the separate insert within the spout.

7. A container according to claim 4 wherein the circumferential flange is joined to a depending outer skirt provided with an insert screw thread adapted to co-operate with a spout screw thread on the tubular spout to secure the insert to the tubular spout.

8. A container according to claim 7 wherein the closure comprises a top panel and a depending closure skirt formed with a closure screw thread and the closure screw thread and insert screw thread are adapted to co-operate with each other to secure the insert within the closure prior to application of the closure to the tubular spout.

9. A container according to claim 8 wherein a bottom edge of the outer skirt has at least one ratchet tooth adapted to co-operate with a slot provided in the tubular spout to hold the insert on the tubular spout when the insert has been screwed onto the tubular spout.

10. A container according to claim 1 wherein the forward portion of the circular spout defines a pouring opening and the liquid outlet comprises from 10% to 50% of the area of the pouring opening.

11. A container according to claim 10 wherein the air inlet comprises from 0.5% to 20% of the area of the pouring opening.

12. An insert for a container as defined in claim 3.

13. A closure cap having a top panel with a depending closure skirt provided with a screw thread, wherein the closure cap has an insert according to claim 12 retained in the closure prior to application of the closure to the tubular spout.

14. (canceled)
